(19) United States
(12) Patent Application Publication
(10) Pub. No.: US 2024/0379078 A1
(43) Pub. Date: Nov. 14, 2024

(54) FLAMENCO CAJON

(71) Applicant: Moises Mas Garcia, Crevillente (ES)

(72) Inventor: Moises Mas Garcia, Crevillente (ES)

(21) Appl. No.: 18/691,852

(22) PCT Filed: Sep. 9, 2022
(86) PCT No.: PCT/ES2022/070567

§ 371 Date: Mar. 13, 2024

(30) Foreign Application Priority Data
Sep. 14, 2021 (ES) U202131820

(51) Int. Cl. G10D 13/02; G10D 13/16; G10D 13/20

(52) U.S. Cl. CPC G10D 13/02; G10D 13/16; G10D 13/20

(57) ABSTRACT

Flamenco cajon with a parallelepiped-shaped structure comprising an upper panel (1) and a lower panel (5) parallel to each other; a front panel (2) incorporating a frame with two horizontal struts, an upper one and a lower one, within which several guitar strings (11) are fastened to said struts, and featuring a tuning system that works by means of string tensioning. These strings are positioned parallel to the front panel (2) and connected to it to produce vibrations when said panel is struck. Internally it has a resonance chamber that is formed by fitting pair of side panels (3, 4) to the frame, with one of said side panels having a hole (6) to allow for the fitting of a mounting device (12) which enables the mounting of a membrane element (7) composed of a drumhead (14) and a circular frame (15), and another of the panels featuring a second hole (9) for the output of the air and sound coming from the resonance chamber.

### CROSS REFERENCE TO RELATED APPLICATIONS

This application claims priority from the PCT application number PCT/ES2022/070567 filed on Sep. 9, 2022 having a priority date of Sep. 14, 2021.

### FIELD OF APPLICATION

The present invention is directed to musical instruments more specifically a variation of the conventional flamenco cajon.

### BACKGROUND OF THE INVENTION

There is currently a wide variety of percussion instruments created for the purposes of reproducing specific sounds with which to make music. Some were developed out of the necessity to cover a certain frequency range (bass, treble), such as the bongos, while others were developed to allow the player to play alone or to accompany other musicians, like the congas, for example. Both instruments share similar characteristics, such as the use of wood and leather in their production, but each one covers a different frequency range, which means that they complement each other perfectly.

A cajon is a percussion instrument that originated in Peru. The original cajons were made from discarded shipping crates. The most common form of the crate is a cube-shaped wooden box constructed in various sizes that is played with the performer sitting on the top surface of the box and striking the outside of the front panel. A typical cajon has a resonant chamber enclosed by the walls or panels of the cajon, with an opening or port formed in the rear panel to produce bass tones from the resonant chamber. Generally, the opening in the rear panel of the body of the cajon allows the release of the air flow resulting from the cajon being struck by the musician, while also serving to amplify the sound coming from inside the cajon.

Metal strings or snares, can optionally be fitted to the inner surface of the front panel (striking surface), and are used to produce a snare sound when the front panel is struck. The walls or panels of the cajon, because they are relatively thin, function as vibrating membranes that perform the same relative function as a conventional drumhead. Striking a cajon panel or a percussive surface at different locations, e.g., the corners, the upper or lower sections, or the central part, can produce a range of different and pleasant percussion sounds. To play the cajon, the performer can usually use his or her hands, fingers, palms, knuckles and nails to produce a multitude of sounds. Mallets, brushes and sticks, or any other suitable elastic or hard object can also be used to this end. Because a cajon can produce a wide variety of sounds when striking different areas of the front panel or side panels of the instrument, and because of its portability, it has become increasingly popular. In addition, the cajon can provide a viable and more cost-effective alternative to a drum kit.

Given that the cajon is an integral instrument in flamenco music and, more recently, in various other musical styles, there is a growing need for a better-sounding cajón. Previous attempts have been made to improve the sound quality produced by a cajon. For example, U.S. Patent U.S. Pat. No. 7,485,790 describes a cajon with wires attached to the interior wherein each wire acts as a damping element. U.S. Pat. No. 7,482,522 also adds a foot pedal and a carpet to change the tone of the instrument. However, there was still an additional need for a drum that would be capable of producing a deeper bass with more resonance, such as that produced by a drum with a membrane drumhead and an open bottom, in addition to the sound produced when hitting wood. However, it is still desirable to have the design and benefits of a cajon, such as the ability to sit on it while playing.

International patent application WO/2013/116317 involves a “cajon” or box-like percussion instrument of cuboid or rectangular shape with six sides. Generally, this consists of five (5) panels of equal thickness with at least one more flexible panel (sixth panel) that vibrates when struck. It includes one or more chambers and a system of inner port openings to improve tonal quality. One or more external port openings, generally rectangular in shape, are formed in the unit to allow the sound to emanate. Different external port geometries are considered including various forms and sizes. Housed within a single unit, the chamber can produce a variety of different tones.

In some models, an inner sound baffle and a reflective block have been introduced to direct sound waves and airflow out of the exterior port opening, thus creating a wider frequency range and greater amplification.

The flamenco cajon, like other percussion instruments of different geometric designs, has a very distinctive sound thanks to the combination of wood and metals, such as guitar strings, bass strings, bells, etc., but they are comprised of a single sound box, which limits their frequency range.

The number of sounds that can be produced with a cajon is limited and the range of available tutorial books, charts and teachings is not as well developed as for other instruments. In addition, the sound levels produced by a cajon can make it overly noisy at times, making it difficult for other instruments to accompany, and making recording quite challenging.

The invention at hand incorporates a number of improvements and possibilities that will increase the recognition and professionalization of this instrument, with the key improvement being the addition of a membrane element on the sides of the traditional flamenco cajon. This membrane element is designed to be made from different types of materials, with different bonding methods and/or skins employed, depending on the effect and sound you want to achieve. In addition, these membrane instruments are characterized by being tuneable, so their structure and size may also vary.

### SUMMARY THE INVENTION

The present invention is directed to a variation of the conventional flamenco cajon, in which one or more membrane elements are added to one or more of its sides. This element, which may be made of leather, synthetic material or wood, produces a sound when struck directly by a hand, rod or drumstick, giving the cajon the function of a sound box. This invention has been conceived and realized with the aim of adding numerous improvements and ways of playing to the original instrument.

The cajon involved in the invention at hand is based on the conventional structure of this type of parallelepiped-shaped instruments, which are defined by a sound box, with a rear sound board with corresponding sound hole and a thinner front panel that is attached by means of screws. Inside, it consists of strings that run vertically, parallel to the front cover, fixed at both ends on two wing nuts and/or tuning screws that are located inside the cajon or, failing that, on the bottom of the cajon.

In accordance with the fundamental features of the invention, the cajon features a hole or opening to which the aforementioned membrane drum is mounted. Depending on the use, this may be positioned on either or both sides of the cajon and it may be the case that there are one or several membrane drums used to produce different types of sound in the same sound box or in the individual sound boxes fitted inside it. This will allow for the creation of new rhythms and compositions, while also providing a new use for the cajon, which should lead to greater recognition for both the instrument itself and this new invention.

The disclosed invention is a flamenco cajon with a parallelepiped-shaped structure comprising an upper panel (1) and a lower panel (5) parallel to each other; a front panel (2) incorporating a frame with two horizontal struts, an upper one and a lower one, within which several guitar strings (11) are fastened to said struts, and featuring a tuning system that works by means of string tensioning. These strings are positioned parallel to the front panel (2) and connected to it to produce vibrations when said panel is struck. Internally it has a resonance chamber that is formed by fitting pair of side panels (3, 4) to the frame, with one of said side panels having a hole (6) to allow for the fitting of a mounting device (12) which enables the mounting of a membrane element (7) composed of a drumhead (14) and a circular frame (15), and another of the panels featuring a second hole (9) for the output of the air and sound coming from the resonance chamber.

### BRIEF DESCRIPTION OF THE DRAWINGS

To complement the description of the instrument and to help provide a more accurate understanding of the features of the invention, a set of drawings has been enclosed which shows its ideal practical realization. These drawings form an integral part of this description, and represent the following in an illustrative, but non-limiting way:

FIG. 1—Shows an exploded view of the general elements of the invention.

FIG. 2—Sample of a 2D plan of the arrangement and tuning system of the strings in the inside of the flamenco cajon.

FIG. 3—Shows a view of the membrane element (7) with the incorporated drumhead (14) and with four screws (13) on the circular frame (15) for fastening and tuning.

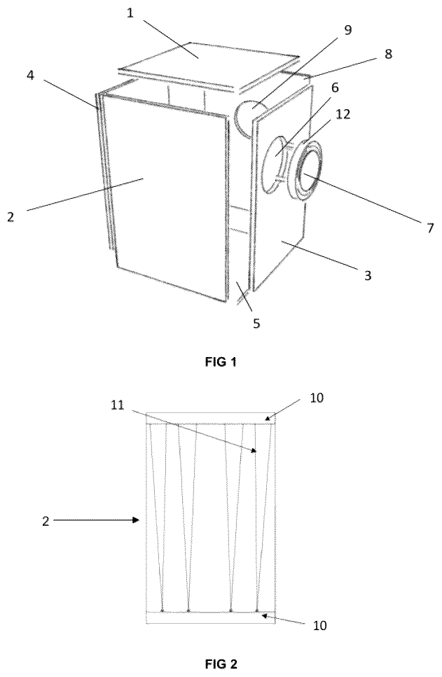

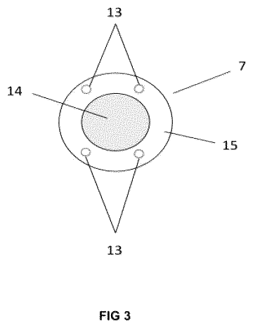

### DESCRIPTION OF THE INVENTION

The flamenco cajon involved in this invention incorporates at least one essential membrane element, which is tuneable, and which is positioned on at least one of the side panels of the traditional flamenco cajon. This membrane instrument is designed to be manufactured in different types of materials, with both its bonding method and its skin varying, depending on the effect and sound that we wish to achieve. Similarly, its structure and size can also vary. The use of different types of materials in the membrane drum will allow this instrument to adapt to all types of musical genres, as well as allowing the instrumentalist to play variations never-before performed and to interpret works or arrangements of others.

Likewise, the mounting of the membrane drum structure to the flamenco cajon by means of adhesive, screws (incl. bolts), or pressure, means that neither of these two components creates vibrations which modify or muddy the sound.

The improved flamenco cajon involved in this invention starts with a structure that is essentially parallelepiped-shaped and comprises a top panel (1) and a bottom panel (5) parallel to each other; a front panel (2) incorporating a frame with two horizontal struts (10), one at the top and one at the bottom, where numerous guitar strings (11) are inserted parallel to the front panel (2) and connected to this panel to produce vibrations when the aforementioned panel is struck. In addition, they have a tuning system which involves tightening the strings (11) which are fixed to the lower strut (10) via wing nuts. This allows the tension of the strings to be modified to create different tunings; a pair of side panels (3,4) are configured for attaching to the frame, with at least one of said side panels (3, 4), having at least one drilled hole (6) for the insertion of a mounting device (12) that allows the incorporation of a membrane element (7) consisting of a drum head (14) and a circular frame (15) wherein the membrane element (7) is fixed to the mounting device (12) by means of at least four screws (13) arranged on the perimeter of the circular frame (15) of the membrane element (7) and with the drumhead (14) of the membrane element (7) being tuneable by adjusting the screws (13); and a rear panel (8) that incorporates an opening (9) for sound output.

One of the main improvements of this invention is that it produces different types of useful sounds inside the main sound box by creating individual sound boxes for each membrane instrument, which results in improved harmony between the various sounds and nuances of the instrument, so that the internal part of the flamenco cajon of the invention may incorporate at least one closed resonance chamber at the location where the hole (6) has been drilled for the introduction of the membrane element (7), in such a way that the resonance chamber matches up with the hole (6) in one of the side panels (3, 4) where the membrane element (7) is mounted. In addition, a second hole is drilled in said side panels (3,4) to match up with the internally arranged resonance chamber that allows the air coming from said resonance chamber to escape.

At the same time, from a harmonic point of view, there is no failure or delay whatsoever in the sound transmission of the original cajon. Moreover, it produces a small harmonic that increases the intensity of the notes. In addition to the advantages explained above, this variation of the traditional flamenco cajon with the mounting of a membrane drum, provides a myriad of possibilities, both technical and professional, in the application of this new instrument, allowing for the development of didactic material for this instrument, increasing its musical-cultural interest and creating an evolution of traditional music.

It is important to emphasize that by means of the screws (13), the membrane element (7), can also be fastened to the mounting element (12), that the membrane element (7) can be fine-tuned, and that further tightening of the screws (13) increases the rigidity of the drumhead (14) which results in an altered sound, and when the screws are loosened the flexibility of the drumhead (14) produces a different sound again. The drumheads can be of different sizes, but ideally they are manufactured in two sizes—approximately 155 mm and 126 mm in diameter—where the width of the circular frame (15) is approximately 15 mm and the thickness is approximately 12 mm.

1. Flamenco cajon with a parallelepiped structure characterized by the inclusion of an upper panel (1) and a lower panel (5) parallel to each other; a front panel (2) incorporating a frame with two horizontal struts (10), an upper one and a lower one, where numerous guitar strings (11) positioned parallel to the front panel (2) are inserted and connected to said panel to produce vibrations upon hitting it; a pair of side panels (3, 4) configured to be attached to the frame, where at least one of said side panels (3, 4) is provided with at least one hole (6) for the insertion of a mounting device (12) which can house a membrane element (7) consisting of a drumhead (14) and a circular frame (15); and a rear panel (8) incorporating an opening (9) for the sound output.

2. Flamenco cajon as per claim 1, characterized by the fact that internally it has at least one closed resonance chamber in the place where the hole (6) has been made for the mounting of the membrane element (7).

3. Flamenco cajon as per claims 1, characterized by the fact that at least one of the panels (3, 4) coinciding with the resonance chamber arranged internally, has a second hole for the outlet of the air coming from the resonance chamber.

4. Flamenco cajon as per claim 1, characterized by the fact that the set of strings (11), attached to the two struts at the bottom and at the top, have a tuning system which functions by means of string tension which is applied via wing nuts on the lower strut, thus allowing the tension of the strings to be modified in order to create different tunings.

5. Flamenco cajon as per claim 1 characterized by the fact that the membrane element (7) is fastened to the mounting device (12) by means of at least four screws (13) arranged around the perimeter of the circular frame (15) of the membrane element (7). This fastening of the membrane element (7) allows the drumhead (14) to be tuned by adjusting the screws (13).

6. Flamenco cajon as per claims 2, characterized by the fact that at least one of the panels (3, 4) coinciding with the resonance chamber arranged internally, has a second hole for the outlet of the air coming from the resonance chamber 7.
